(19) United States
(12) Patent Application Publication
(10) Pub. No.: US 2014/0234608 A1
(43) Pub. Date: Aug. 21, 2014

(54) Colored polymeric molded bodies, and method and device for producing the molded bodies

(71) Applicants: Christian Kohlert, Oberahr (DE); Bernd Schmidt, Gackenbach (DE); Andreas Schnabel, Montabaur (DE); Frank Michels, Heilberscheid (DE); Alexander Razigraev, St. Petersburg (RU); Tamara Chistyakova, St. Petersburg (RU); Marco Schaaf, Molsberg (DE)

(72) Inventors: Christian Kohlert, Oberahr (DE); Bernd Schmidt, Gackenbach (DE); Andreas Schnabel, Montabaur (DE); Frank Michels, Heilberscheid (DE); Alexander Razigraev, St. Petersburg (RU); Tamara Chistyakova, St. Petersburg (RU); Marco Schaaf, Molsberg (DE)

(73) Assignee: KLÖCKNER PENTAPLAST GMBH, Heiligenroth (DE)

(21) Appl. No.: 14/343,939

(22) PCT Filed: Sep. 7, 2012
(86) PCT No.: PCT/EP2012/003767

§ 371 Date: Apr. 14, 2014

(30) Foreign Application Priority Data
Sep. 15, 2011 (DE) 10 2011 113 543.3

(51) Int. Cl. C08J 3/20; B29C 67/00; B01F 15/00; C08J 5/18; B01F 15/02

(52) U.S. Cl. CPC C08J 3/20; C08J 5/18; B01F 15/0216; B01F 15/00272; B29C 67/0007
USPC 428/220; 524/567; 524/570; 524/599; 524/585; 524/582; 524/606; 524/577; 524/605; 524/560; 106/171.1; 366/152.2; 425/135

(57) ABSTRACT

A method is provided for producing colored molded bodies based on the following steps: (a) plasticising a polymeric material and blending the material with one or more dyes to form a molding compound by means of a gelation unit equipped with a metering apparatus for dyes; (b) optionally temporarily storing the molding compound obtained in step (a); (c) charging a molding device with the molding compound; and (d) producing the molded body; wherein the ratio of dye to polymeric material is automatically regulated using a colorimeter and an electronic control, and in step (a) color values are measured at the molding compound located in the gelation unit and transmitted as a signal to the electronic control.

The present invention relates to a process for the production of one or more moldings, comprising the steps of
(a) plastification of a polymeric material and mixing with one or more dyes to give a molding composition by means of a gelling assembly equipped with a metering device for dyes;
(b) optional intermediate storage of the molding composition obtained in step (a);
(c) supplying the molding composition to a molding device; and
(d) producing the molding;
   where the quantitative ratio of dye to polymeric material is regulated automatically by means of a colorimeter and an electronic control system.

The invention further relates to an apparatus for the process, and also to a foil produced by the process.

Processes for the production of colored moldings are known.

U.S. Pat. No. 5,723,517 A discloses a system which is intended for the production of colored polymeric molding compositions and which comprises a gelling assembly with a supply system for polymeric material and with a metering apparatus for dyes, and which comprises a color sensor and an electronic control, system. The color sensor measures the color of the molding composition discharged from the gelling assembly and transmits this as signal to the electronic control system. The electronic control system comprises an algorithm for the regulation of the metering apparatus and, respectively, of the quantity of dye introduced per unit of time into the gelling assembly. The experiments described in U.S. Pat. No. 5,723,517 A were carried out with a twin-screw extruder with screw diameter 28 mm, and a delay time or reaction time of 40 s was observed from this system. The expression delay time or reaction time means the time that elapses between an undesired pulse-type event and correction thereof by the system—another term often used for this in technical circles being pulse response. In the present case, the pulse response corresponds to the interval between a momentary increase in the amount of a dye introduced and the automatic return of the color of the extruded molding composition to a prescribed desired value. U.S. Pat. No. 5,723,517 A gives no indication of the extruder throughput, i.e. the quantity of polymer that passed through the twin-screw extruder per unit of time. It is therefore impossible to determine the quantity of polymer that passed through the system during the 40 s pulse response. The screw diameter, only 28 mm, implies that the twin-screw extruder used in U.S. Pat. No. 5,723,517 A is a laboratory extruder with low throughput, from a few kg up to 20 kg per minute. Accordingly, the quantity of polymer passed through the system during the pulse response is less than 20 kg.

In the industrial manufacture of plastics moldings, high productivity and high throughput are desirable. By way of example, production of plastics foils from polyvinyl chloride (PVC), from polyethylene terephthalate (PET), or from polyolefins, such as polypropylene (PP) usually achieves a production throughput and foil speed of from 60 to 200 m/min and, respectively, from 1.0 to 3.4 m/s, where the mass throughput depends on the thickness of the foil produced and is from 100 to 4000 kg/h and, respectively, from 1.7 to 67 kg/s. Production speeds of this type require that color be controlled and regulated with minimized pulse response time.

Another factor to be considered is that, in industrial manufacture, the composition of the parent polymeric material often varies during production: recyclate is often added to the parent material, and in foil production by way of example this takes the form of edge-trim that continuously arises. The composition and color of the parent material can vary considerably, depending on the quantity, distribution, and color of the recyclate. With the known systems for color monitoring and color control it is not always possible to comply with the increasingly stringent quality requirements placed upon plastics moldings, and in particular placed upon plastics foils.

Accordingly, it is an object of the present invention to provide a process for the production of polymeric moldings with improved color control.

Said object is achieved via a process comprising the steps of:
(a) plastification of a polymeric material and mixing with one or more dyes to give a molding composition by means of a gelling assembly equipped with a metering device for dyes;
(b) optional intermediate storage of the molding composition obtained in step (a);
(c) supplying the molding composition to a molding device; and
(d) producing the molding;
   where the quantitative ratio of dye to polymeric material is regulated automatically by means of a colorimeter and an electronic control system, and in step (a) color coordinates are measured on the molding composition located in the gelling assembly and are transmitted as signal to the electronic control device.

Features of advantageous embodiments of the process of the invention are that:
in step (d) further color coordinates are measured by means of a further colorimeter on the molding and are transmitted as signal to the electronic control system;
the polymeric material introduced into the gelling assembly comprises recyclate; and/or
the amount of the polymeric material introduced per unit of time into the gelling assembly is measured and transmitted as signal to the electronic control system.

Another object of the present invention is to provide an apparatus for the production of polymeric molding compositions and moldings with little color variation. This object is achieved via an apparatus comprising a gelling assembly which has a metering device for one or more dyes and which is intended for the plastification and mixing of a polymeric material with dye to give a molding composition, a first colorimeter, and an electronic control system which has connection to the metering device and to the first colorimeter and which is intended for the automatic regulation of the quantitative ratio of dye to polymeric material, where the first colorimeter is equipped to detect electromagnetic radiation emitted from the molding composition present in the gelling assembly, in particular visible light with wavelengths in the range from 380 to 780 nm.

Features of advantageous embodiments of the apparatus of the invention are that:
the first colorimeter is coupled by means of an optical conductor, in particular by means of a glass fiber, to the space within the gelling assembly;
the apparatus comprises a supply system which has connection to the electronic control system and which is intended for supplying polymeric material to the gelling assembly, where the electronic control system and the supply system are equipped to regulate the quantity of the polymeric material introduced per unit of time into the gelling assembly;
the apparatus comprises a supply system which has connection to the electronic control system and which is intended for supplying polymeric material to the gelling assembly, where the supply system is equipped to measure the quantity of the polymeric material introduced per unit of time into the gelling assembly, and to transmit said quantity as signal to the electronic control system;
the apparatus comprises a molding device for the production of one or more moldings, such as foil or fibers;
the apparatus comprises a second colorimeter which has connection to the electronic control system and which is equipped to detect electromagnetic radiation emitted from the molding;
the first and second colorimeter mutually independently comprise one or more optically absorptive bandpass filters or wavelength-dispersive deflection elements, such as gratings or prisms, and also one or more optoelectronic sensors, such as CCD sensors or CMOS sensors; and
the apparatus comprises one or more temperature sensors connected to the electronic control system, an example being an infrared camera to measure the temperature of the molding composition and/or of the molding.

Another object of the present invention is to provide a colored foil with little color variation.

This object is achieved via a foil made of a polymeric material and of dyes with width from 0.1 to 6 m, length from 100 to 10,000 m, local color coordinates Eₖ=(L*ₖ, a*ₖ, b*ₖ), and an average color coordinate E_{M}=(L*_{M}, a*_{M}, b*_{M}) where

$${L}_{M}^{*} = \frac{1}{N} {\sum }_{k = 1}^{N} {L}_{k}^{*} ;$$

$${a}_{M}^{*} = \frac{1}{N} {\sum }_{k = 1}^{N} {a}_{k}^{*} ;$$

$${b}_{M}^{*} = \frac{1}{N} {\sum }_{k = 1}^{N} {b}_{k}^{*} ;$$

N is a natural number from 5 to 100, and deviations ΔEₖ of the local color coordinates Eₖ from the average color coordinate E_{M} are smaller than 1.0, where

ΔEₖ=\sqrt{(L*ₖ−L*_{M})²+(a*ₖ−a*_{M})²+(b*ₖ−b*_{M})²}

and the color coordinates Eₖ in the longitudinal direction of the foil are measured at a distance of s±0.05·s, where s is from 1 to 100 m.

A feature of an advantageous embodiment of the foil of the invention is that the deviations ΔEₖ of the local color coordinates Eₖ from the average color coordinate E_{M} are smaller than 0.8, smaller than 0.6, smaller than 0.4, smaller than 0.3, preferably smaller than 0.2, and in particular smaller than 0.1.

The invention is explained in more detail below by reference to figures.

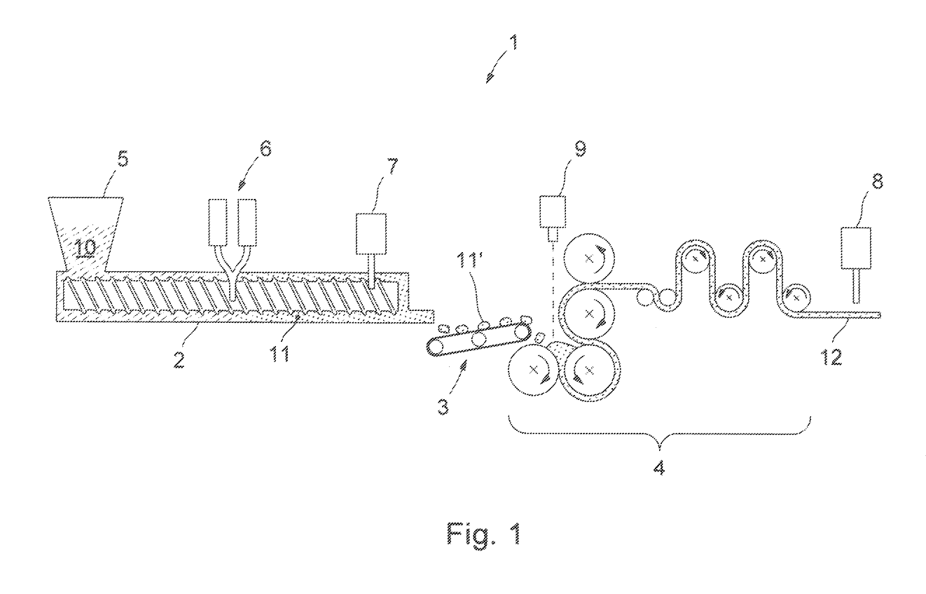

FIG. 1 shows an apparatus for the production of colored polymeric moldings;

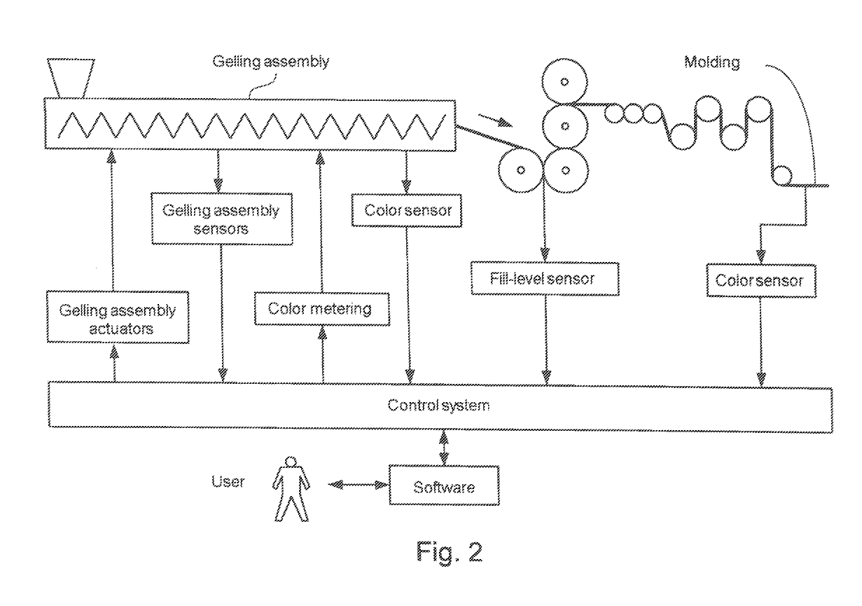

FIG. 2 shows a design of a control system for the apparatus; and

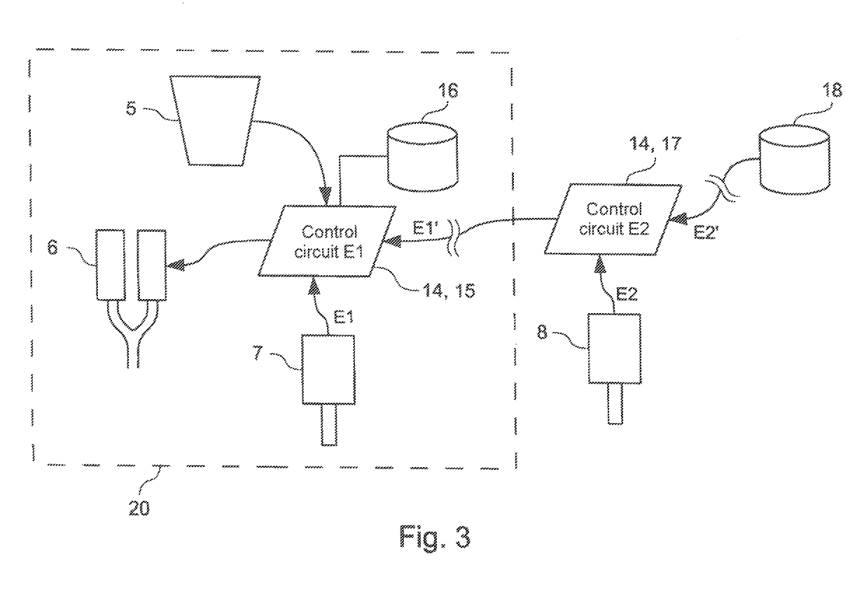

FIG. 3 shows a system for regulating the color coordinate of the polymeric moldings.

FIG. 1 shows an apparatus 1 with a gelling assembly 2, a supply system 5 for the supply of a polymeric material 10 to the gelling assembly 2, and with a metering device 6 for one or more dyes, and with a colorimeter 7. The gelling assembly 2 plasticizes the polymeric material 10 and mixes it with one or more dyes introduced by way of the metering device 6 to give a molding composition 11. The polymeric material 10 comprises a parent material and optionally recyclate. The parent material, which is preferably provided in the form of a granulate, comprises a homo- or copolymer, for example polyvinyl chloride, a polyolefin, a polyester, polyethylene, polypropylene, polyamide, polystyrene, polyethylene terephthalate, cellulose acetate, polymethyl methacrylate, or polylactide. The parent material can comprise, alongside the polymer, additives such as fibers of natural and/or synthetic origin, plasticizers, and stabilizers. The same applies to the composition of the recyclate. It is preferable that the composition of the recyclate corresponds in essence to the composition of the parent material. The recyclate can moreover comprise one or more dyes.

The gelling assembly 2 preferably takes the form of co-kneader extruder, planetary-gear extruder, or single-screw or twin-screw extruder. An outlet from the gelling assembly 2 takes the form of simple die with circular or polygonal cross section, of spinneret for filaments, or of slot die for foils. In one advantageous embodiment of the apparatus 1 of the invention, the outlet from the gelling assembly 2 takes the form of circular die and is equipped with a chopper which divides the strand-type extruded molding composition 11 into cylindrical sections 11′.

In one advantageous embodiment of the apparatus 1 of the invention, the supply system 5 comprises a feed container to receive the polymeric material 10, and also a conveying device, for example a conveying screw, by means of which it is possible to vary the quantity of polymeric material 10 introduced per unit of time into the gelling assembly 2, another term used for this below being throughput. The conveying device of the supply system 5 comprises a regulatable electrical drive which can be connected to an electronic control system. By means of the electronic control system it is possible to regulate the drive of the conveying device, and to adjust the quantity of the material 10 introduced per unit of time into the gelling assembly 2, i.e. the throughput, automatically and continuously as required by the production process.

In one advantageous embodiment of the apparatus 1 of the invention, the supply system 5 is equipped with a measurement device for the continuous detection of the throughput of polymeric material 10. The measurement device by way of example takes the form of electronic balance or of microwave transmitter-receiver with integrated evaluation electronics, and can be connected to the electronic control system, so that it is possible to transmit, to the electronic control system, a signal that is proportional to the throughput. This embodiment of the apparatus of the invention permits advance calculation of the quantities of dyes that are added per unit of time to the plastified polymeric material 10 by means of the metering equipment 6, and adjustment of said quantities as required by the throughput or mass throughput of the polymeric material 10 in the gelling assembly 2. The transfer time of the polymeric material 10 within the gelling assembly 2 is taken into consideration here, this being the time that is required to transport the polymeric material 10 from the supply system 5 as far as the feed point(s) of the metering device 6 for the dyes. As explained below, the arrangement has the feed point(s) of the metering device 6 for the dyes between the supply system 5 and an outlet from the gelling assembly 2.

The metering device 6 comprises n feed containers, where n=1, 2, 3, 4, 5, 6, 7 or 8, for pulverulent or liquid dyes. The feed containers with the dyes have connection to the space within the gelling assembly 2 by way of separate lines, which optionally lead to a shared line. Each of the feed containers, or each of the separate lines, is equipped with a conveying device, such as a pump or a screw. The conveying device is designed to convey the dye under a pressure of from 1 bar up to several hundred bar into the gelling assembly 2, and the pressure generated by the conveying device here is higher than the pressure generated in the gelling assembly 2 during the plastification of the polymeric material 10. Each of the conveying devices for dye comprises a regulatable electrical drive which can be connected to the electrical control system, so that the quantity of each of the dyes introduced per unit of time into the gelling assembly can be regulated separately by means of the electronic control system.

It is preferable to use liquid dyes, these being injected into the gelling assembly 2 by means of an electrically driven pump and a lance equipped with a nozzle.

The arrangement has the supply systems for the dyes, or the lances for the dyes, at a distance of from D/3 to 2·D/3 from the opening at the end of the feed system 5, based on a distance D between the point at which the supply system 5 for polymeric material 10 opens into the gelling assembly 2 and the outlet from the gelling assembly 2, in the conveying or longitudinal direction of the gelling assembly 2.

The arrangement has the colorimeter 7 or the measurement point of the colorimeter 7 between the metering device 6 and the outlet from the gelling assembly 2 in the conveying direction or longitudinal direction of the gelling assembly 2. It is preferable to use a plurality of colorimeters 7 in order to measure the color coordinate of the molding composition 11 at various positions within the gelling assembly 2 and, from the individual measurements, to calculate an averaged color coordinate.

The colorimeter 7 comprises imaging optics, one or more optoelectronic sensors, and optionally wavelength-dispersive deflection elements or color filters. The imaging optics preferably take the form of optical conductors made of glass, or take the form of glassfiber optics. The arrangement of the input side of the imaging optics in the gelling assembly 2 is such that a portion of the electromagnetic radiation emitted from the molding composition 11, in particular visible light with wavelengths in the range from 380 to 780 nm, is input into the optical conductor or into the glassfiber and, directly or by way of the optional deflection elements or color filters, is imaged onto one or more optoelectronic sensors. There is moreover a light source provided to illuminate the molding composition 11 comprised in the gelling assembly 2. To the extent that the light source, which by way of example is a halogen lamp or an LED (light-emitting diode) is integrated within the colorimeter 7, the light emitted from the light source is input into the optical conductor by way of a beam divider in order to illuminate the molding composition 11. A portion of the light emitted or reflected from the molding composition 11 is imaged onto the optoelectronic sensor by way of the optical conductor, the beam divider, and the optional deflection elements or color filters. In an alternate embodiment of the invention, a separate optical conductor or a window in the wall of the gelling assembly 2 is used in order to illuminate the molding composition 11 with the light from the light source.

The colorimeter 7 can take the form of spectrometer and can comprise a plurality of, in particular three, color filters, and a reflection grating or transmission grating or a prism as wavelength-dispersive deflection element. In the case of the spectrometer, electrooptical sensors preferably used are photodiodes or a linear CCD line sensor or linear CMOS line sensor with in each case by way of example 8 k=8192 pixels, in order to detect the spectral intensity distribution of the light emitted from the molding composition 11 and transmitted through the color filters or deflected by the diffraction grating or prism in accordance with its wavelength.

The colorimeter 7 can moreover take the form of color camera, and can comprise a CCD sensor or CMOS sensor in each case with color filter, in particular with Bayer, Sony RGBE, Super-CCD EXR, RGBW, CYGM, or CMYW filter.

In another embodiment, the colorimeter 7 takes the form of color camera with three CCD sensors or three CMOS sensors and with a prism which divides the image into a red fraction, green fraction, and blue fraction.

The size of the area imaged and measured by means of the colorimeter 7, or the size of the corresponding beam cross section of the light reflected or scattered from the molding composition 11 and detected by the colorimeter 7 is preferably from 0.2 mm. to 20 cm². The arrangement of the colorimeter 7 or of the imaging optics of the colorimeter 7 in the gelling assembly 2 is such that light detected is exclusively that reflected or scattered from the molding composition 11, and is not that reflected or scattered from periodically rotating mechanical components such as extruder screws, kneading teeth, or kneading blades. In an alternate embodiment of the invention, the output signal from the colorimeter 7 is filtered electronically or digitally or by software, in order to eliminate the undesired periodic signals from mechanical components.

In one advantageous embodiment of the apparatus 1, the gelling assembly 2 is equipped with one or more temperature sensors, in particular with thermometers, arranged on the inside of the gelling assembly 2 in the vicinity of the measurement position of the colorimeter 7 and equipped to determine the temperature of the molding composition 11. In another embodiment of the apparatus 1 of the invention, a temperature sensor takes the form of separate infrared camera or of infrared camera integrated into the colorimeter 7, whereupon a portion of the infrared radiation emitted from the molding composition 11 is imaged onto an electrooptical or pyroelectric sensor of the infrared camera by way of an optical conductor made of glass. The temperature sensor can be connected to the electronic control system, so that a signal proportional to the temperature of the molding composition 11 can be transmitted to the electronic control system. The temperature of the molding composition 11 or the signal transmitted from the temperature sensor to the electronic control system can be used for the calibration of the color coordinate measured by the colorimeter 7 for the molding composition 11.

As described above, the gelling assembly 2 with its supply system 5, the metering device 6, the colorimeter 7, and the electronic control system form the components that are essential to the invention in the apparatus 1. In advantageous embodiments of the invention, the apparatus 1 moreover comprises a molding device for the production of one or more moldings, such as foils, fibers, or injection moldings.

FIG. 1 depicts, as molding device, by way of example a calender device 4 for foils 12. The calender device 4 comprises a calender roll stack with k calender rolls, where k=3, 4, 5, 6, 7, 8, 9, 10, 11 or 12, one or more take-off rolls, and optionally a transverse stretching frame not depicted in FIG. 1, these being arranged after the calender roll stack in machine direction, i.e. in the direction of running of the molding composition 11′ or of the foil 12.

Molding composition 11′ extruded from the gelling assembly 2 is passed by means of a transport device 3 onto a first calender roll or to a first nip between a first and second calender roll. The temperatures of the first and second, and also optionally of further, calender rolls are controlled, and the temperature of the first calender roll here is regulated to a value in the range from 160 to 210° C. Accordingly, the molding composition 11′ located before the first nip has been plastified. In each unit of time, a portion of the molding composition 11′ is drawn through the first nip and, on the second calender roll, is passed to the second nip between the second and third calender roll. Once the molding composition 11′ or the foil 12 has passed through the nip of the final calender roll pair, it is passed over the take-off rolls, and also optionally through the optional transverse stretching frame. By means of the take-off rolls and of the optional transverse stretching frame it is possible to stretch the foil 12 in machine direction and respectively perpendicularly to the machine direction, i.e. in transverse direction.

In one advantageous embodiment of the apparatus 1 of the invention, there is a fill-level detector 9 provided in order to measure the quantity of the molding composition 11′ before the first nip. It is preferable that the principle of measurement of the fill-level detector 9 is based on contactless propagation time measurement by means of ultrasound, radar, or laser light, where the molding composition 11′ situated before the first nip is exposed to the respective radiation and the radiation reflected by the molding composition 11′ is detected. Propagation time measurement by means of laser light or radar, in particular by means of microwaves with a frequency in the range from 6 to 25 GHz, uses the frequency-modulated continuous-wave method (FMCW) or the pulse method.

The fill-level detector 9 can be connected to the electronic control system, so that a signal that is proportional to the quantity of the molding composition 11′ situated before the first nip can be transmitted to the electronic control system and can be utilized for the automatic regulation of the quantity of polymeric material 10 introduced per unit of time into the gelling assembly 2 by means of the supply system 5.

It is preferable that the apparatus 1 of the invention comprises a further colorimeter 8 that is equipped, and arranged in a suitable position, to measure a color coordinate of the molding 12 produced by means of the apparatus 1, in particular of a foil 12, and to transmit said coordinate to the electronic control system. The design of the colorimeter 8 can be the same as that of the colorimeter 7. Equally, the principle of measurement of, and the design of, the colorimeters 7 and 8 can differ from one another. In particular, the colorimeter 8 requires no optical conductor or glass fiber in order to guide the light emitted from the molding 12 onto the electrooptical sensor. Instead, the colorimeter 8 can be equipped with a conventional camera objective and can be arranged within line of sight of the molding 12.

There is moreover a light source provided in order to illuminate the molding 12 in a defined and reproducible manner. The light source, which by way of example is a halogen lamp or an LED (light-emitting diode), can be integrated into the colorimeter 8 or can be separate therefrom.

The size of the area imaged and measured by means of the colorimeter 8, or the size of the corresponding beam cross section of the light detected by the colorimeter 8 is preferably from 0.2 mm² to 60 cm².

In one advantageous embodiment of the apparatus 1 of the invention, there is an additional temperature sensor provided, in particular an infrared camera, in order to determine the temperature of the molding 12 at the measurement position of the colorimeter 8. The temperature sensor can be connected to the electronic control system, so that a signal proportional to the temperature of the molding 12 can be transmitted to the electronic control system and can be used for the calibration of the color coordinate measured by the colorimeter 8.

The invention further provides that a drive of the gelling assembly 2 can be connected to the electronic control system, and that the rotation rate of the gelling assembly 2 can be regulated and/or detected by means of the electronic control system, and can be used as parameter in the control program.

FIG. 2 is a graphic representation of the design of the control system of the invention, according to which the gelling assembly and the molding device comprise various actuators, measurement devices, and sensors linked to a central software-controlled control system or to an electronic control system. The output signals from the measurement devices and sensors are transmitted to the electronic control system. The output signals are digitalized by the electronic control system or by the interfaces present therein, and are processed as variable parameters in the control program.

FIG. 3 uses a block diagram to show the automatic regulation of the color coordinate E1 of the molding composition 11. As described above, the gelling assembly 2 with its supply system 5, the metering device 6, the colorimeter 7 and an electronic control system identified by the reference sign 14 in FIG. 3 form the components essential to the invention in the apparatus 1. The electronic control system 14 comprises or implements a first control circuit 15 and optionally a second control circuit 17. The electronic control system 14 preferably takes the form of programmable logic controller (PLC) or of computer with the Microsoft Windows or Linux operating system, and it comprises electronic interfaces for linking actuators and sensors, examples being electric motors, colorimeters, and thermometers. The electronic control system 14 comprises, alongside a microprocessor, main memory, in particular DRAM or flash EEPROM to accept a control program, which has been stored on a local or external storage medium, in particular on a hard disk, and which when the electronic control system 14 is switched on or is initialized, is loaded into the main memory, where it is optionally permanently retained.

The electronic control system 14 advantageously has connection to a network, in particular to a local area network (LAN), so that data and programs can be transmitted from and to computers in the network. It is preferable to use a network based on the Ethernet protocol or TCP/IP.

In a first embodiment of the invention indicated in FIG. 3 by the dashed rectangle 20, the supply system 5, the metering device 6, and the colorimeter 7 have connection to the electronic control system 14.

One embodiment of the invention moreover provides a temperature sensor not shown in FIG. 3 that is equipped to determine the temperature of the molding composition 11 at or in the vicinity of the measurement position for the color coordinate E1, and that has connection to the electronic control system 14. The signal transmitted from the temperature sensor to the electronic control system 14 serves for the calibration of the color coordinate E1 measured by the colorimeter 7.

The control program of the electronic control system 14 comprises a command sequence which is executed with a frequency that depends on the computation power and clock frequency of the microprocessor of the electronic control system 14: several thousand to several million times per second. The command sequence comprises commands and algorithms for requesting sensor signals and for the calculation and output of control signals for actuators. The control program executed by the microprocessor of the electronic control system 14 implements a first control circuit 15 for the color coordinate E1 of the molding composition 11. As explained above, the color coordinates measured by means of the colorimeter 7 are filtered electronically or by software in order to eliminate undesired signals from rotating mechanical components of the gelling assembly 2. Accordingly, the control program of the electronic control system 14 comprises an optional routine with variable, adjustable cycle time which can in particular depend on the rotation rate of the gelling assembly 2, for the filtering of the color coordinates of the colorimeter 7.

One advantageous embodiment of the invention provides a database 16 integrated into the electronic control system 14 or linked thereto. The database 16 serves for the recording and provision of process data over long periods, and forms an essential component for knowledge-based regulation of the color coordinate E1. In particular, the process data stored in the database 16 can be utilized for the advance calculation of the quantities of dye to be added per unit of time by means of the metering device 6, on the basis of the throughput of polymeric material 10. The invention provides the use of various control algorithms, based inter alia on fuzzy logic or on neural networks. The process data stored in the database 16 are utilized to write control algorithms of this type and/or for process control per se.

As shown in FIG. 3, for the first control circuit 15 a desired value E1′ is prescribed for the color coordinate E1 of the molding composition 11. The color coordinate E1 measured by the colorimeter 7 can deviate from the desired value E1′ because of accidental variations or process-related alterations of the composition and/or of the quantity of the polymeric material 10 introduced per unit of time into the gelling assembly 2. To the extent that the difference ΔE1=E1−E1′ between the current color coordinate E1 and the desired value E1′ is below or above a prescribed negative or positive threshold value, actuation values or actuation signals are calculated from the difference ΔE1 in accordance with the algorithm of the control circuit 15, and are transmitted to the corresponding actuators. In particular, actuator values or actuator signals are transmitted to conveying devices, such as pumps or conveying screws for the various dyes available in separate containers of the metering device 6. The desired value E1′ is read into the electronic control system 14 prior to the start of a production batch, and is usually kept constant until manufacture of the production batch has been completed. In an alternate embodiment of the invention, the desired value E1′ is varied during the course of a production batch. The desired value E1′ can be input by means of a keyboard, bar code reader, or the like, or can be read from a data source, such as the database 16.

In one advantageous embodiment of the invention, there is, in addition to the first colorimeter 7, a second colorimeter 8 attached to the electronic control system 14 in order to measure the color coordinate E2 of the molding 12. The molding 12 is illuminated by means of a light source, for example a halogen lamp or an LED (light-emitting diode), integrated into the colorimeter 8 or separate therefrom. In this embodiment of the invention, the electronic control system 14 comprises, alongside the first control circuit 15, a second control circuit 17 which, in accordance with a control algorithm, calculates a desired value E1′ from a difference ΔE2=E2−E2′ between the color coordinate E2 measured by means of the second colorimeter 8 and a prescribed desired value E2′, and transmits said desired value E1′ to the first control circuit 15. The desired value E1′ determined by the second control circuit 17 can vary during the course of a production batch.

The use of a second colorimeter 8 is particularly advantageous when the color coordinate E2 of the molding 12 deviates noticeably from the color coordinate E1 of the molding composition 11. Noticeable deviations between E1 and E2 can occur inter alia during manufacture of foils by means of a calender. The molding composition 11 or 11′ is exposed in the calender to a temperature in the range from 160 to 210° C., and to a high mechanical pressure, and this inter alia reduces the degree of polymerization (DP) of the molding composition 11′. The molding composition 11 and the molding 12 can moreover have different optical properties, e.g. different optical reflectance of the surface and sometimes different scattering within the material, because of density variations.

By using two control circuits 15 and 17 with respectively one or more colorimeters 7 and 8, the invention provides a process and an apparatus for the rapid correction of the relevant color coordinate E2.

An advantageous embodiment of the invention provides a further database 18, integrated into the electronic control system 14 or linked thereto. The database 18 serves for the recording and provision of process data for the second control circuit 17, and forms an essential component for knowledge-based calculation of the desired value E1′. In particular, the process data stored in the database 18 can be utilized for fuzzy-logic-based calculation of the desired value E1′. The invention provides the use of various calculation algorithms for the desired value E1′, based inter alia on fuzzy logic or on neural networks.

A desired value E2′ is prescribed for the color coordinate E2 of the molding 12 for the second control circuit 17. The desired value E2′ is read into the electronic control system 14 prior to the start of a production batch, and is kept constant until manufacture of the production batch has been completed. The desired value E2′ is input by means of a keyboard, bar code reader, or the like, or is read from a data source, such as the database 18.

One embodiment of the invention moreover provides a temperature sensor not shown in FIG. 3 that is equipped to determine the temperature of the molding 12 at or in the vicinity of the measurement position for the color coordinate E2 and that has connection to the electronic control system 14. The signal transmitted from the temperature sensor to the electronic control system 14 serves for the calibration of the color coordinate E2 measured by the colorimeter 8.

The color coordinates Eₖ=(L*ₖ, a*ₖ, b*ₖ) of a foil produced by the process of the invention are determined by a colorimeter which, as explained above in the context of the colorimeter 7 and 8, takes the form of spectrometer or of color camera. It is preferable that the color coordinates E, are measured at the same foil position in transverse direction, i.e. perpendicularly to the machine direction or perpendicularly to the longitudinal axis of the foil web. This reduces variations in the color coordinates measured caused by foil inhomogeneity in transverse direction which are sometimes caused by transverse stretching, in particular by the effect which in technical circles is called “bow”. In machine direction, the color coordinates Eₖ are measured equidistantly at a constant distance s of about 1 m to 100 m from one another, where the distance between two adjacent measurement positions can deviate by ±5%, i.e. by an amount of ±0.05·s, from the measurement distance s prescribed.

It is preferable that the color coordinates E1, E2 and Eₖ are determined in accordance with DIN ISO 6174:2007-10(D). To the extent that the colorimeters 7 and 8 used, and also the colorimeter used for color measurement on a foil produced in the invention, for example an RGB color camera, do not measure within the L*a*b* color space, the color coordinates obtained in accordance with DIN ISO 6174:2007-10(D) are converted by calculation into the corresponding L*a*b* coordinates. It is preferable here that the transformation from the RGB color space to the L*a*b* color space is achieved by way of XYZ color coordinates.

1. A process for the production of one or more moldings, comprising the steps of
(a) plastifying a polymeric material and mixing with one or more dyes to give a molding composition by means of a gelling assembly equipped with a metering device for dyes;
(b) optionally storing the molding composition obtained in step (a);
(c) supplying the molding composition to a molding device; and
(d) producing the molding;
where the quantitative ratio of dye to polymeric material is regulated automatically by means of a colorimeter and an electronic control system,
wherein step (a) further comprises measuring color coordinates on the molding composition located in the gelling assembly and transmitting these measurements as signal to the electronic control system.

2. The process as claimed in claim 1, wherein step (d) further comprises measuring color coordinates by means of a further colorimeter on the molding and transmitting these measurements as signal to the electronic control system.

3. The process as claimed in claim 1, wherein the polymeric material introduced into the gelling assembly comprises recyclate.

4. The process as claimed in claim 1, wherein said process further comprises introducing an amount of polymeric material into the gelling assembly and measuring the amount of the polymeric material introduced per unit of time into the gelling assembly and these measurements as signal to the electronic control system.

5. An apparatus comprising a gelling assembly which has a metering device for one or more dyes and which plastifies and mixes a polymeric material with dye to give a molding composition, a colorimeter, and an electronic control system connected to the metering device and to the colorimeter which automatically regulates the quantitative ratio of dye to polymeric material, wherein
the colorimeter is equipped with an electromagnetic radiation detector that detects electromagnetic radiation emitted from the molding composition present in the gelling assembly.

6. The apparatus as claimed in claim 5, wherein the colorimeter is coupled by means of an optical conductor, to a space within the gelling assembly.

7. The apparatus as claimed in claim 5, wherein the apparatus further comprises a supply system connected to the electronic control system which supplies polymeric material to the gelling assembly, where the electronic control system and the supply system are equipped to regulate the polymeric material quantity introduced per unit of time into the gelling assembly.

8. The apparatus as claimed in claim 5, wherein the apparatus further comprises a supply system connected to the electronic control system which supplies polymeric material to the gelling assembly, where the supply system is equipped to measure the polymeric material quantity introduced per unit of time into the gelling assembly and to transmit said quantity as signal to the electronic control system.

9. The apparatus as claimed in claim 5, wherein the apparatus further comprises a molding device for producing one or more moldings.

10. The apparatus as claimed in claim 9, wherein the apparatus comprises a further colorimeter connected to the electronic control system and which is detects electromagnetic radiation emitted from the molding.

11. The apparatus as claimed in claim 10, wherein the colorimeter and the further colorimeter mutually independently comprise one or more optically absorptive bandpass filters or wavelength-dispersive deflection elements and also one or more optoelectronic sensors.

12. The apparatus as claimed in claim 5, wherein the apparatus further comprises one or more temperature sensors connected to the electronic control system measuring the temperature of the molding composition and/or of the molding.

13. A foil comprising a polymeric material and dyes, said foil having a width from 0.1 to 6 m, length from 100 to 10,000 m, local color coordinates Eₖ=(L*ₖ, a*ₖ, b*ₖ), and an average color coordinate E_{M}=(L*_{M}, a*_{M}, b*_{M}) where
$${L}_{M}^{*} = \frac{1}{N} {\sum }_{k = 1}^{N} {L}_{k}^{*} ;$$
$${a}_{M}^{*} = \frac{1}{N} {\sum }_{k = 1}^{N} {a}_{k}^{*} ;$$
$${b}_{M}^{*} = \frac{1}{N} {\sum }_{k = 1}^{N} {b}_{k}^{*} ;$$
N is a natural number from 5 to 100,
wherein
deviations ΔEₖ of the local color coordinates Eₖ from the average color coordinate E_{M} are smaller than 1.0, where
ΔEₖ=\sqrt{(L*ₖ−L*_{M})²+(a*ₖ−a*_{M})²+(b*ₖ−b*_{M})²}
and the color coordinates Eₖ in the longitudinal direction of the foil are measured at a distance of s±0.05·s, where s is from 1 to 100 m.

14. The foil as claimed in claim 13, wherein the deviations ΔEₖ of the local color coordinates Eₖ from the average color coordinate E_{M}, are smaller than 0.8.

15. The apparatus as claimed in claim 6, wherein the optical conductor is a glass fiber.

16. The apparatus as claimed in claim 9, wherein the molding is a foil or fiber.

17. The apparatus as claimed in claim 11, wherein the bandpass filters or wavelength-dispersive deflection elements are gratings or prisms and the optoelectronic sensors are CCD sensors or CMOS sensors.

18. The apparatus as claimed in claim 12, wherein the temperature sensors are an infrared camera.

19. The foil as claimed in claim 14, wherein the deviations ΔEₖ of the local color coordinates Eₖ from the average color coordinate E_{M} are smaller than 0.6.

20. The foil as claimed in claim 14, wherein the deviations ΔEₖ of the local color coordinates Eₖ from the average color coordinate E_{M} are smaller than 0.4.

21. The foil as claimed in claim 14, wherein the deviations ΔEₖ of the local color coordinates Eₖ from the average color coordinate E_{M} smaller than 0.3.

22. The foil as claimed in claim 14, wherein the deviations ΔEₖ of the local color coordinates Eₖ from the average color coordinate E_{M} are smaller than 0.2.

23. The foil as claimed in claim 14, wherein the deviations ΔEₖ of the local color coordinates Eₖ from the average color coordinate E_{M} are smaller than 0.1.
